(19) United States
(12) Patent Application Publication
(10) Pub. No.: US 2004/0113933 A1
(43) Pub. Date: Jun. 17, 2004

(54) Split and merge behavior analysis and understanding using Hidden Markov Models

(75) Inventor: Sadiye Zeyno Guler, Winchester, MA (US)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: NORTHROP GRUMMAN CORPORATION

(21) Appl. No.: 10/680,086

(22) Filed: Oct. 7, 2003

Related U.S. Application Data
(60) Provisional application No. 60/416,553, filed on Oct. 8, 2002.

(51) Int. Cl. G09G 5/00

(52) U.S. Cl. 345/716; 345/723

(57) ABSTRACT

A process for video content analysis to enable productive surveillance, intelligence extraction, and timely investigations using large volumes of video data. The process for video analysis includes: automatic detection of key split and merge events from video streams typical of those found in area security and surveillance environments; and the efficient coding and insertion of necessary analysis metadata into the video streams. The process supports the analysis of both live and archived video from multiple streams for detecting and tracking the objects in a way to extract key split and merge behaviors to detect events. Information about the camera, scene, objects and events whether measured or inferred, are embedded in the video stream as metadata so the information will stay intact when the original video is edited, cut, and repurposed.

### CROSS-REFERENCE TO RELATED APPLICATION AND CLAIM OF PRIORITY

This present application is related to U.S. Provisional Application No. 60/416,553 filed on Oct. 8, 2002.

### FIELD OF THE INVENTION

The present invention relates generally to digital video analysis; and more specifically, to real-time digital video analysis from single or multiple video streams.

### BACKGROUND ART

The advent of relatively low-cost and high resolution digital video technology has made digital video surveillance systems a common tool for infrastructure protection, as well as other applications for consumer, broadcast, gaming, and other industries. By solving the problems associated with analog video, digital video technology has made video information easier to collect and transmit. However, digital video technology has created a new problem in that increasingly larger volumes of video images must be analyzed in a timely fashion to support mission critical decision-making.

A general assumption frequently made for video surveillance, either analog or digital, is that the analyst is looking for specific activities in a small fraction of the large volumes of video data.

Hence, automating the process of video analysis and detection of specific events has been of particular interest as noted in W. E. L. Grimson, C. Stauffer and R. Romano, “Using Adaptive Tracking to Classify and Monitor Activities in a Site”, Proc. IEEE Conf. On Computer Vision and Pattern Recognition, pp. 22-29, 1998; J. Fan, Y. Ji, and L. Wu, “Automatic Moving Object Extraction Toward Content-Based Video Representation and Indexing,” Journal of Visual Communications and Image Representation, vol. 12, no. 3, pp. 217-239, September 2001; and Haritaoglu, D. Harwood and L. Davis, “W4: Who, When, Where, What: A Real-time System for Detecting and Tracking People”, Proc 3^{rd} Face and Gesture Recognition Conf, pp. 222-227, 1998. New tools and methodologies are needed to help video operators analyze and retrieve event specific video images in order to enable efficient decision-making.

### DISCLOSURE/SUMMARY OF THE INVENTION

It is therefore an object of the present invention to provide a method for analyzing event specific video images.

Another object of the present invention is to provide a method for retrieving event specific video image analysis.

The above-described objects are fulfilled by a method for video analysis and content extraction. The method includes scene analysis processing of a video input stream. The scene analysis may include scene change detection, camera calibration, and scene geometry estimation. For each scene, object detection and tracking is performed. Split and merge behavior analysis is performed for event understanding. In a further embodiment, the behavior analysis results are stored in the video input stream.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

The present approach allows for automation of both the real-time and post-analysis processing of video content for event detection. Highlights of the process include:

A new concept for detecting activities based on “split and merge” behaviors. These behaviors are defined as a tracked object splitting into two or more objects, or two or more tracked objects merging into a single object. These low-level behaviors are used to model higher-level activities such as package drop-off or exchange between people, people getting in and out of cars or forming crowds, etc. These events are modeled using a directed graph including at least one or more split and/or merge behavior states. This representation fits into a Hidden Markov Model (HMM) framework.

Embedding all the analysis results into the video stream as metadata using Society of Motion Picture and Television Engineers (SMPTE) standard Key Length Value (KLV) encoding, thereby facilitating the repurposing and distribution of video data together with the corresponding analysis results saving video analyst and operator time.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level diagram of a video analysis framework used in an embodiment of the present invention;

FIG. 2 is an example of track association as performed using an embodiment of the present invention;

FIG. 3 is a graph representation of split and merge behaviors detected using an embodiment of the present invention;

FIG. 4 is a graph representation of a compound split merge event detected using an embodiment of the present invention;

FIG. 5 is an example video sequence of a complex event detected using an embodiment of the present invention;

FIG. 6 is a high level diagram of the flow of video information having embedded metadata according to an embodiment of the present invention;

FIG. 7 is a graph representation of a compound merge event detected using an embodiment of the present invention;

FIG. 8 is a directed graph representation for the split/merge behaviors according to an embodiment of the present invention;

FIG. 9 is an HMM representation of a time sampled sequence of object features around a merge behavior according to an embodiment of the present invention;

FIG. 10 is a simple split/merge based HMM representation for two person interactions according to an embodiment of the present invention; and

FIG. 11 is a two-level HMM representation based on split and merge transitions according to an embodiment of the present invention.

### BEST MODE FOR CARRYING OUT THE INVENTION

An innovative new framework for real-time digital video analysis from single or multiple streams is described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

Top Level Description

Within the present approach, two principal technical developments are introduced. First, a method to detect and understand a class of events defined as “split and merge events”. Second, a method to embed the video analysis results into the video stream as metadata to enable event correlations and comparisons and to associate the contents for several related scenes. These features of the approach lead to substantial improvements in video event understanding through a high level of automation. The results of the approach include greatly enhanced accuracy and productivity in surveillance, multimedia data mining, and decision support systems.

The video analysis approach starts with automatic detection of scene-changes, including camera operations such as zoom, pan, tilts and scene cuts. For each new scene, camera calibration is performed and the scene geometry is estimated in order to determine the absolute position for each detected object. Objects in a video scene are detected using an adaptive background subtraction method and tracked over consecutive frames. Objects are detected and tracked to identify the key split and merge behaviors where one object splits into two or more objects and two or more objects merge into one object. Split and merge behaviors are identified as key behavior components for higher-level activities and are used in modeling and analysis of more complex events such as package drop-off, object exchanges between people, people getting out of cars or forming crowds, etc.

The computational efficiency of the approach makes it possible to perform content analysis on multiple simultaneous live streams and near real-time detection of events on standard personal workstations or computer systems. The approach is scalable for real-time processing of larger numbers of video streams in higher performance parallel computing systems.

Detailed Description

In a typical video surveillance system, multiple cameras cover a surveyed site, and events of interest take place over a few camera fields of view. Hence, an automated surveillance system must analyze activity in multiple video streams, i.e. one video stream output from each camera. In this regard, automatic external calibration of multiple cameras to obtain an “extended scene” to track moving objects over multiple scenes is known to persons of skill in the art. To support the correlated analysis over a number of video streams, the different scenes in a video stream are identified and the scene geometry is estimated for each scene. Using this approach, the absolute object positions are known, and spatial and temporal constraints are used to associate related object tracks.

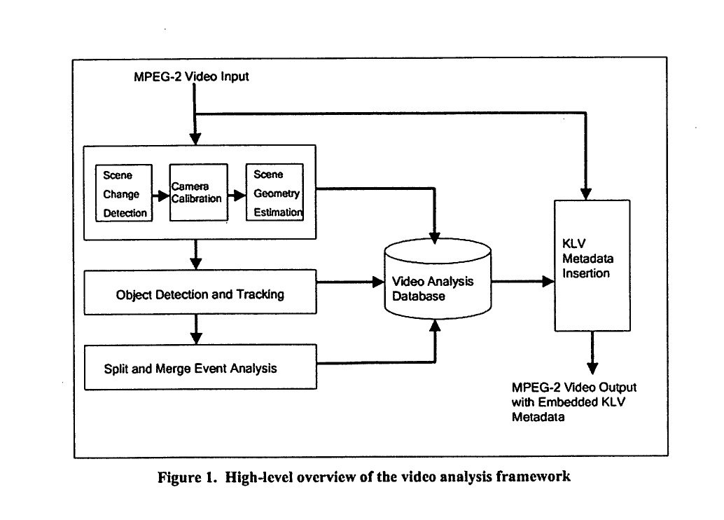

A high-level architectural overview of our video analysis and content extraction framework is depicted in FIG. 1. Video input streams undergo scene analysis processing; including scene-change detection in the MPEG compressed domain, as well as camera calibration and scene geometry estimation. Once the scene geometry is obtained for each scene, objects are detected and tracked over all scenes. This step is followed by Split and Merge behavior analysis for event understanding.

All of the analysis results are stored in a database, as well as being inserted into the video stream as metadata. The detailed description of the database schema is known to persons of skill in the art.

Scene Analysis

Scene analysis is the first step of the video exploitation approach. This step includes three additional steps; namely, scene-change detection in Moving Pictures Experts Group (MPEG) compressed domain, camera calibration using limited measurements, and scene geometry estimation. The present scene analysis procedures assume fixed cameras, which is a reasonable assumption for a large class of surveillance applications; however, the present approach can readily be modified to accommodate camera motion known with reasonable accuracy.

Scene-Change Detection

The problem of detecting scene-changes has been studied by a number of researchers and several solutions have been proposed in the literature. In the present approach, a fast functional solution having the potential to operate in real-time to support automated surveillance is used. Because MPEG-2 video is used, a functional solution using MPEG bitstream information and motion vectors is particularly attractive. A two-level functional solution was used to detect scene-changes due to camera operations such as zoom, pan, tilt and scene cuts. In the first level, the functional solution detects large changes in the bit rate of encoding of I, B and P frames in the MPEG bitstream. In the second level, a functional solution based on analyzing MPEG motion vectors to refine the scene-changes is used. Large changes in the number of bits required to encode a new frame indicates a significant change in scene characteristics.

The first step provides coarse scene-change detection and reduces the number of frames for which the motion vectors have to be analyzed to refine the scene-change detection and determine the type of scene change. The magnitude and direction of motion vectors over the entire frame indicate the type of camera operation. For example, similar magnitude and similar angle motion vectors for each macro block will indicate a camera pan in the associated direction and magnitude. All motion vectors pointing to the image center results from a camera zoom in operation and all motion vectors pointing away from the image center results from a camera zoom out operation. Using this two-level functional solution, very accurate and fast scene-change detection in the MPEG compressed domain is achieved. However, for every new scene detected in a video stream, camera calibration is required to obtain the scene geometry.

Camera Calibration

Camera calibration is the process of calculating or estimating camera parameters, including the camera position, orientation and focal length, using a comparison of object and image coordinates of corresponding points. These parameters are required to compute the scene geometry for each scene. There are two more parameters in addition to the ones mentioned above; image scaling (in both x and y direction) and cropping, but in the present approach no scaling, square pixels, and no cropping as is the case with surveillance video is assumed.

The amount of camera information available varies depending on the source of the subject video scene. Three types of video collection situations providing varying amounts of information include:

1. Cooperative Collection in which a full set of camera parameters is available for each scene;

2. Semi-cooperative Collection in which only partial camera or scene information is available, which may be used to bound the scene, and;

3. Un-cooperative Collection in which most, if not all, camera and scene information is not available and cannot be obtained. Camera calibration, in this situation, requires estimation of relative parameters and some human operator judgment to bound the solution.

To address all these types of video data, the present approach assumes that any or all three camera parameters (focal length f, the position vector d, or the orientation matrix Q) can be unknown. The following cases are identified by the unknown parameters (f), (d), (d, f), (Q), (Q, f), (Q, d) and the exact or approximate solution for camera calibration problem for each case is derived. When the camera orientation Q is known, the unknowns (f), (d) or (d, f) of the first three cases are solved by a linear least squares procedure.

If the orientation Q is unknown, there is no closed form solution. In this case, an initial search is used to find a starting point for a non-linear least squares iterative homing process to solve for unknown camera orientation. In the last two cases where, in addition to Q, other unknowns like f or d exist, some estimate of minimum and maximum values for f or d are required to limit the range of these parameters to be able to obtain the estimates of the camera parameters.

Scene Geometry

Reasoning and inferencing based on the content of video streams must take place within a relative or absolute geometric framework. When a camera produces an image, object points in the scene (the real world) are projected onto image points in the picture. To formalize and describe the relationship between object and image coordinates the parameters that describe the imaging process, the camera calibration parameters, are required. Given a set of object coordinates and all the camera parameters discussed in the previous section (assuming no scaling and cropping), there is a unique set of image coordinates, but the reverse is not true. Hence, the relationship between the real world and image coordinates are established beginning with the object coordinates. This transformation may be represented by a 4×4 camera transformation matrix M, including translation based on the camera distance to object d, rotation based on the orientation Q of the camera and projection based on the focal length f. Hence the transformation of object point ho to image point, is obtained by:

$${h}_{i} = {Mh}_{o} where M = \vert \begin{matrix}Q & Qd \\ {f}^{T} Q & {f}^{T} Qd\end{matrix} \vert .$$

As stated earlier the reverse transformation from hᵢ to h₀ is not possible without some additional information, such as the distance of the object point from the projection center, i.e. the camera. This constraint information is already available from the camera calibration. Using this constrained approach, coordinate transformations among object, image, and geodetic coordinates are performed.

Object Detection and Tracking

The next step of the process is the segmentation of the objects in the scene from the scene background and tracking of those objects over the frames of a video stream or over multiple video streams. For a typical stationary surveillance camera, a slowly varying background is assumed. The functional solution adapts to small changes in the background while large changes may be detected as a scene cut. The scene background B is generated by averaging a sequence of frames that do not include any moving objects. This is often a reasonable expectation in a surveillance environment. However, since the background image is continuously updated with each new frame, even if obtaining a clear background view is not possible, the effect of objects previously in the scene gradually averages out.

Each image pixel is modeled as a sample from an independent Gaussian process. During the background generation, a running mean and standard deviation is calculated for each pixel. After generation of the background, for each new frame, pixel value changes within two standard deviations are considered part of the background. This model allows for slow changes in the background, such as wind generated motion of leaves and grass, lighting variations, etc. The generated background B is subtracted from each new frame F to obtain the difference image D. Horizontal, vertical, and diagonal edge operators are applied to the difference image to detect the foreground objects. A pixel f_{x,y} of F is classified as an edge pixel if either one of the following conditions hold:

(f_{x-1,y-1}+f_{x,y-1}+f_{x+1,y-1})−(f_{x-1,y+1}+f_{x,y+1}+f_{x+1,y+1})>t

(f_{x-1,y-1}+f_{x-1,y}+f_{x-1,y+1})−(f_{x+1,y-1}+f_{x+1,y}+f_{x+1,y+1})>t

(f_{x-1,y-1}+f_{x,y-1}+f_{x-1,y})−(f_{x+1,y}+f_{x,y+1}+f_{x+1,y+1})>t

(f_{x,y-1}+f_{x+1,y-1}+f_{x+1,y})−(f_{x-1,y+1}+f_{x-1,y}+f_{x,y+1})>t

where t is an optimal threshold.

A morphological operator is used to close the edge contours into segments and each segment represents an object F^{O}. An object size constraint is applied to eliminate small spurious detections. After the foreground objects F^{O} (i=1 to N, where N is the number of objects in the current frame) are established for each frame, the current background region F^{B} (F^{B}=F−F^{O}, i=1 to N) is used to upgrade the initial background image pixels as follows:

b_{x,y}=(1−α) b_{x,y}+αf^{B}_{x,y}

where α<1 is the background adaptation rate. For increased performance, object detection processing is in gray-level; however, once the object regions are established the color information is retrieved just for the object pixels F_{x,y}^{Oi}. The color information is obtained as coarse histograms in the color space (27 bins in the RGB color cube) for each object region.

The first order statistics of each object region (mean μ and the standard deviation σ of brightness value), the pixel area P, its center location (x,y), and established direction of motion v constitute the features of each object. The tracking algorithm uses the object features to link the object regions in successive frames based on a cost function. The cost function is constructed to penalize the abrupt changes in tracked object size, position, direction and color statistics. For each object, Oᵢ^{k} in k'th frame, the existence of the position of the corresponding object region Oᵢ^{k+1} is determined, in the next frame by minimizing the weighted sum of the differences in μ, σ, P, v and (x, y), over all the objects in that frame.

$$\begin{matrix}{O}_{i}^{k + 1} = {argmin}_{j} \{ {w}_{1} \vert {μ}_{j •}^{ k + T} {μ}_{i • •}^{ k} \vert + \\ {w}_{2} \vert {σ}_{j •}^{ k + T} {σ}_{i •}^{ k} \vert + \\ {w}_{3} \vert {P}_{j •}^{ k + T} {P}_{i •}^{ k} \vert + \\ {w}_{4} \vert {v}_{j •}^{ k + T} {v}_{i •}^{ k} \vert + \\ {w}_{5} ( ‖ {x}_{j •}^{ k + T} {x}_{i • •}^{ k} ‖ + ‖ {y}_{j •}^{ k + T} {y}_{i • }^{ k} ‖ )\end{matrix}$$

where 0<w₁<1 are used to weigh these object features.

The color information is used to resolve conflicts in frame to frame tracking or across scene association of object tracks. The objects are detected and tracked over the sequence of frames to obtain a motion profile. Objects are tracked across scenes in two for each object in the scene and to create track associations across scenes.

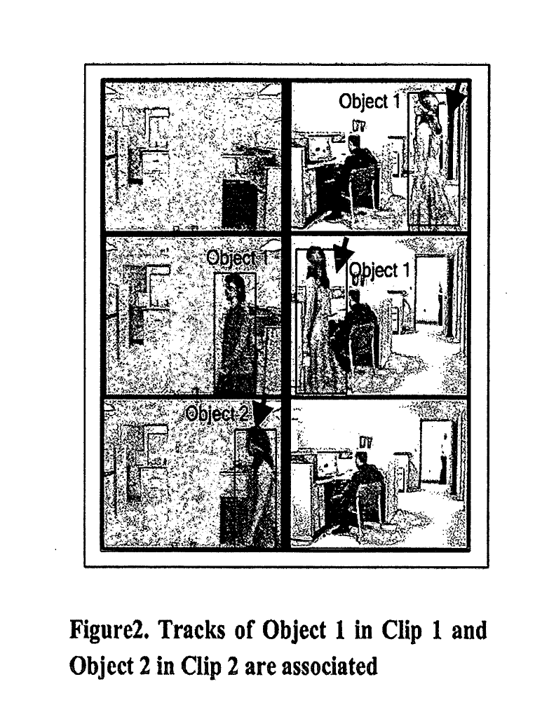

Tracking objects across scenes in two different use cases is envisioned. First, in postprocessing mode, scene geometry and video time stamp information is used. Second, in near-real-time operation, a camera ID for Field of View (FOV) correspondence is used. In post-processing, once all the objects in scenes are detected and tracked with true position information and results are stored in the video database, the extended tracks for objects of a scene are constructed by physical location and time constraints. An example of this type of track association is shown in FIG. 2. The right column depicts three frames from video stream Clip1, and the left column shows frames from video stream Clip2. There is no overlap between the FOV's of the two scenes. First, objects are detected and tracked for both clips and stored in the database and as metadata. Later, due to overlapping timestamp information of the clips, the tracked objects are compared using position and frame time information. This information suggests associating the tracks of Object1 in Clip1 with Object1 in Clip2, but checking the color histograms prevents this association. Further search supports the association of tracks of Object1 in Clip1 with Object2 in Clip2. In near real-time operation, when an object leaves a scene in a specific direction, the scene from the camera with the neighboring FOV is correlated to object features for each new object entering the scene in a specific direction, to determine the track continuations.

Split and Merge Event Analysis

To understand object behaviors, also referred to as events, in video scenes, both individual behaviors of single objects and relationships among multiple objects must be understood and simple components of more complex behaviors need to be resolved. A hierarchical structure for events includes simple atomic behaviors at a first level including one action or interaction such as “wait”, “enter”, and “pick up;” These simple behaviors constitute the components of higher-level activities or events such as “meeting”, “package drop-off” or “exchange between people”, “people getting in and out of cars” or “forming crowds”, etc. Two event detection methods identify various events from video sequences, namely a layered Hidden Markov Model built upon split and merge behaviors and an expert system rules based approach. Interfaces for these event detection tools operate on the video data in the database for training, detection and indexing the video files based on the detected events enabling the video event mining.

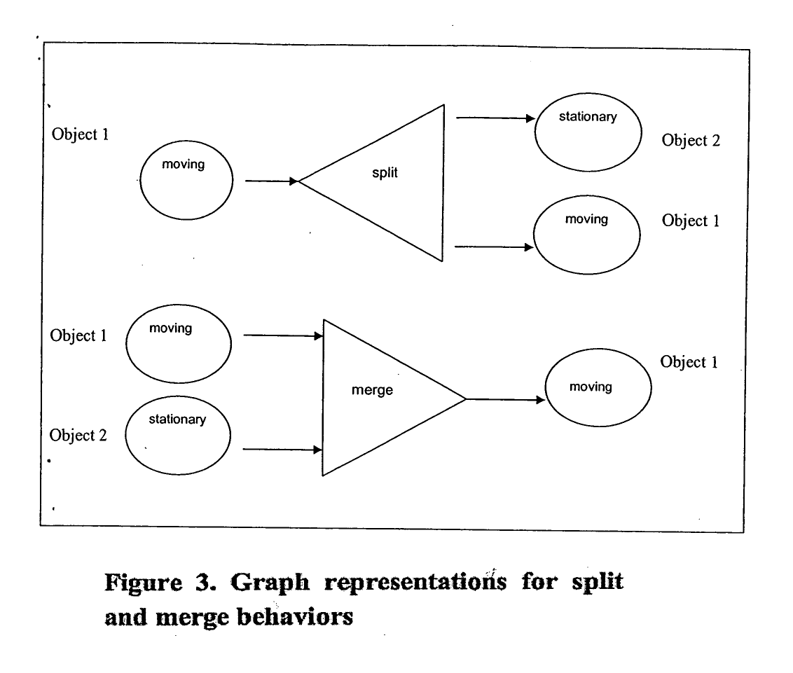

Analyzing the activities of interest for surveillance applications, common simple behavior components have been identified that can be considered key behaviors for certain classes of events; specifically, the split and merge behaviors. High level events based on the split/merge behaviors are modeled using a directed graph including one or more split and/or merge behavior transition as illustrated in FIG. 3. Examples of split and merge based events are quite common in the surveillance domain. A tracked object splitting into two or more objects can be, for example, a component behavior in a package drop-off event, a person getting out of a car, or one leaving a group of other people. Two tracked objects merging into one object may be, for example, a person getting picked up by a vehicle, a person picking up a bag, or two people meeting and walking together. Split and Merge behaviors are formally defined below.

Let A^{k}ᵢ and Âᵢ^{k+1} denote the bounding box for object i in frame k and the estimated bounding box for object i in frame k+1, respectively.

The split and merge behaviors are then defined as follows:

Split Behavior: Object Oᵢ^{k} of frame k is said to split into two objects Oᵢ^{k+1} and Oⱼ^{k+1} in frame k+1 if,

Âᵢ^{k+1}∩(Aᵢ^{k+1}∪Aⱼ^{k+1})≠Ø and

m(Âᵢ^{k+1})=r.m(Aᵢ^{k+1}∪Aⱼ^{k+1})

where m(A^{k}ᵢ) denotes the measure of the bounding box A^{k}ᵢ, (the count of all pixels belonging to Oᵢ that are included in A^{k}ᵢ) and r is a coefficient to control the amount of overlap expected between the split objects and the parent object. In one embodiment, 0.5<r<1 as a coefficient to control the amount of overlap required between the bounding boxes for the split objects and the parent object. In another embodiment, 0.7<r<1.3 as a coefficient.

Merge Behavior: Objects Oᵢ^{k} and Oⱼᵢ^{k} of frame k is said to have merge in Oₗ^{k+1} in frame k if;

Aₗ^{k+1}∩(Âᵢ^{k+1}∪Âⱼ^{k+1})≠Ø and

m(Aₗ^{k+1})=r.m(Âᵢ^{k+1}∪Âⱼ^{k+1})

where r is chosen as above. This parameter controls the amount of overlap required between the bounding boxes for the merged object and the child objects.

As depicted in FIG. 3, these events can be modeled using a directed graph including at least one or more split and/or merge behavior states.

Events including only one split and/or merge behavior component are characterized as simple events.

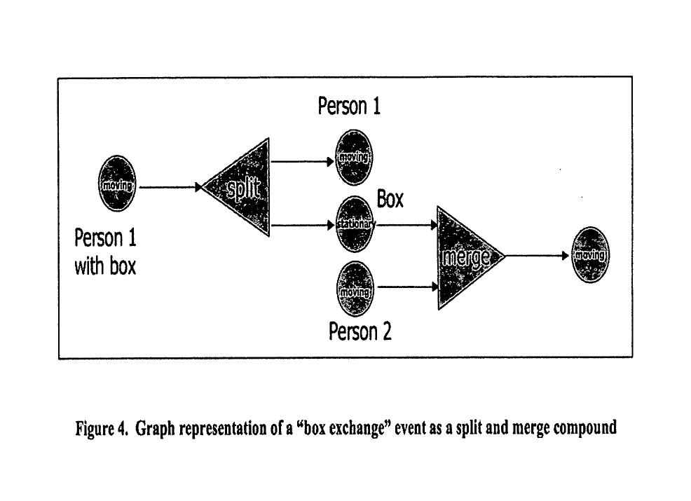

Events in which there are more than one split and/or merge behavior component are defined as compound split merge events or complex events. An example compound split merge event graph for a package exchange between two people is depicted in FIG. 4. Complex events are further characterized as compound and chain split merge events. A categorization for split and merge based events and the three (3) identified event types is described as follows:

Simple (1 split or merge): Events including a single split or merge, e.g., package drop, person getting in or out of a car.

Compound (1 split and 1 merge): Events including a combination of one split and one merge, e.g., package exchange between individuals, two people meet/chat and walk away event. An example compound split merge event graph for a package exchange between two people is depicted in FIG. 4.

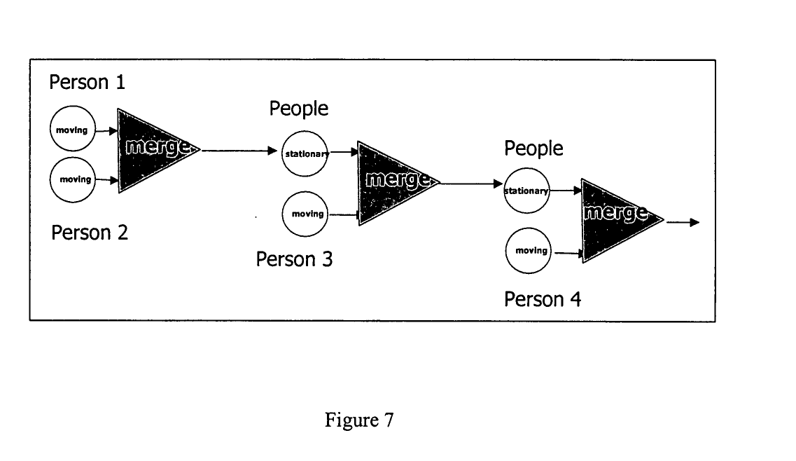

Chain (sequential multiple splits or merges): Events including a sequence of splits or merges, e.g., crowd gathering by individuals joining in, crowd dispersal, queueing, crowd formation (as depicted in FIG. 7).

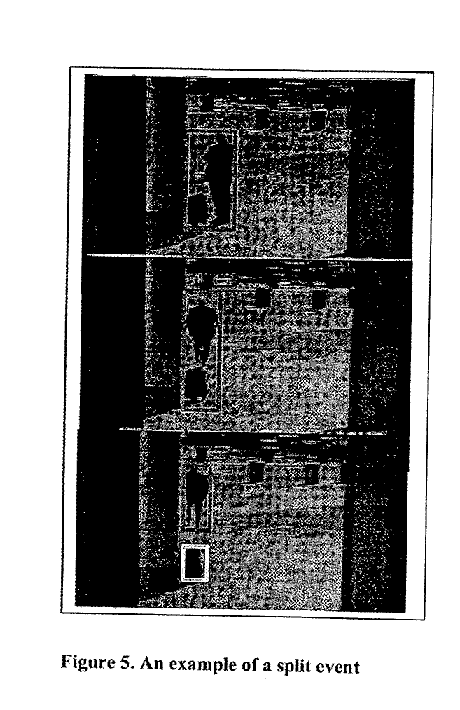

Examples of complex events with both simple split and merge behavior components and compound split and merge components are quite common in the surveillance domain. A tracked object splitting into two or more objects can be, for example, a component behavior in a package drop-off event (FIG. 5), a person getting out of a car, or one leaving a group of other people. Two tracked objects merging into one object can be, for example, a person getting picked up by a vehicle, a person picking up a bag, or two people meeting and walking together.

Representation of Split and Merge Behavior Based Events

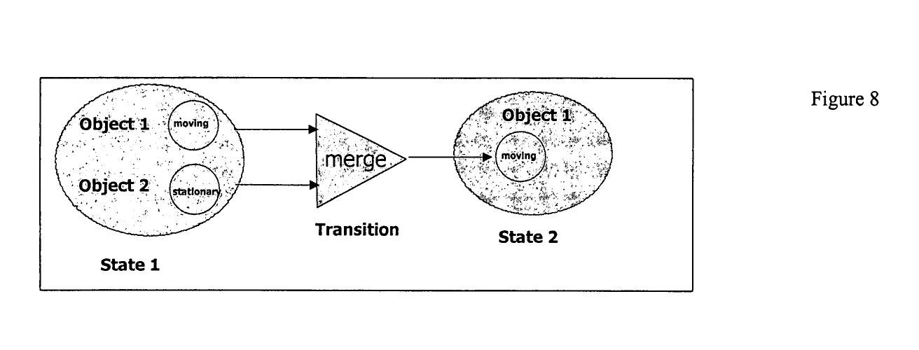

As described above, the simple split and merge behaviors are used as building blocks for more complex events. The directed graph representation for the split/merge behaviors is a transition of objects from one state to another as depicted in FIG. 8. This representation naturally fits into a Hidden Markov Model (HMM).

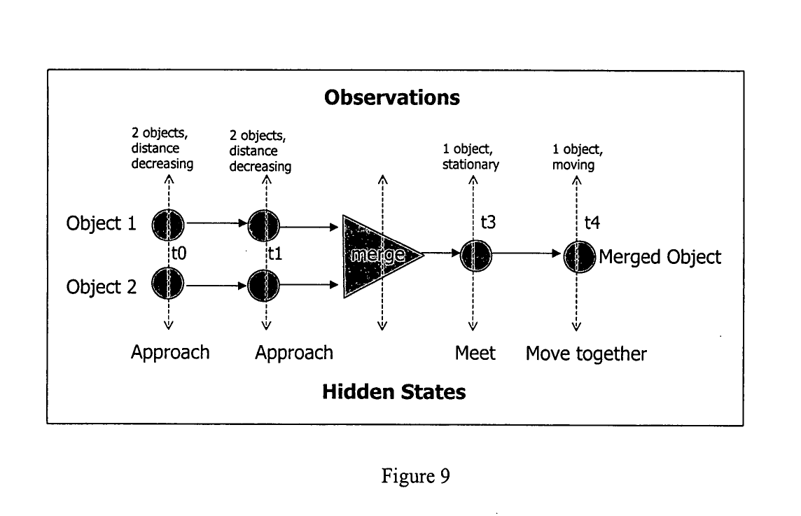

In operation, a sequence of single and relational object features is observed and sampled around a spilt or a merge behavior as shown in FIG. 9. A state is constructed. Using observation samples before and after each Split/Merge transition, an HMM is trained to estimate hidden state sequences, which are then interpreted to understand video events. In an embodiment according to the present approach, HMM analysis is triggered by a split /merge detection and the observation samples are taken five time intervals before and after the split or merge transition.

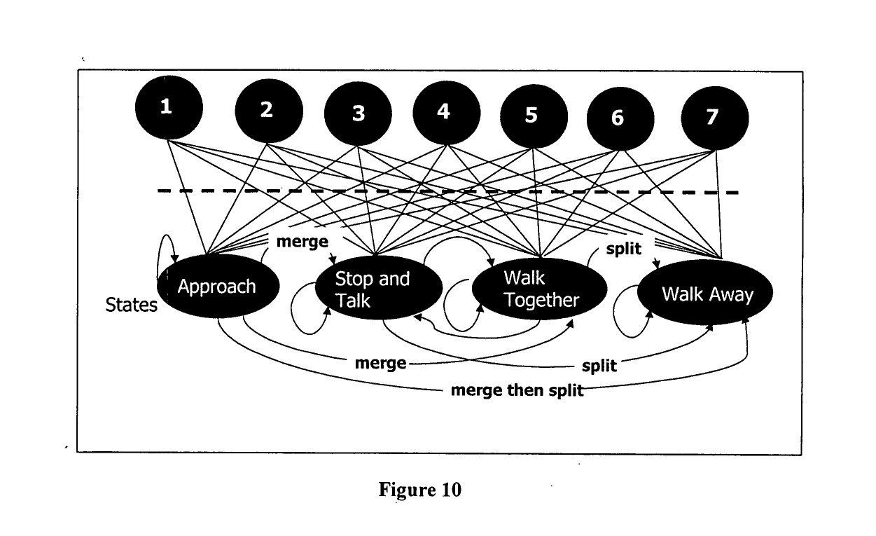

A simple four state split/merge based HMM for two people interactions is depicted in FIG. 10 having seven discrete observations. The four hidden states are: Approach, Stop and Talk, Walk Together, and Walk Away. The observable features chosen for this model include: the number of objects, size, shape and motion status of each object, as well as, the change of distance between the objects. Discrete observations are as follows (corresponding to the seven (7) observations of FIG. 10):

1.) 2 objects, people shape and size, 1 object moves, distance between objects decreases;

2.) 2 objects, 2 objects move, people shape and size, distance between objects decreases;

3.) 2 objects, none move, people shape and size, distance between objects stays constant;

4.) 1 object, people shape and size, 1 object moves;

5.) 1 object, none move, people shape and size;

6.) 2 objects, people shape and size, 1 object moves, distance between objects increases; and

7.) 2 objects, people shape and size, both objects move, distance between objects increases.

2-Level HMM for Split and Merge Event Detection

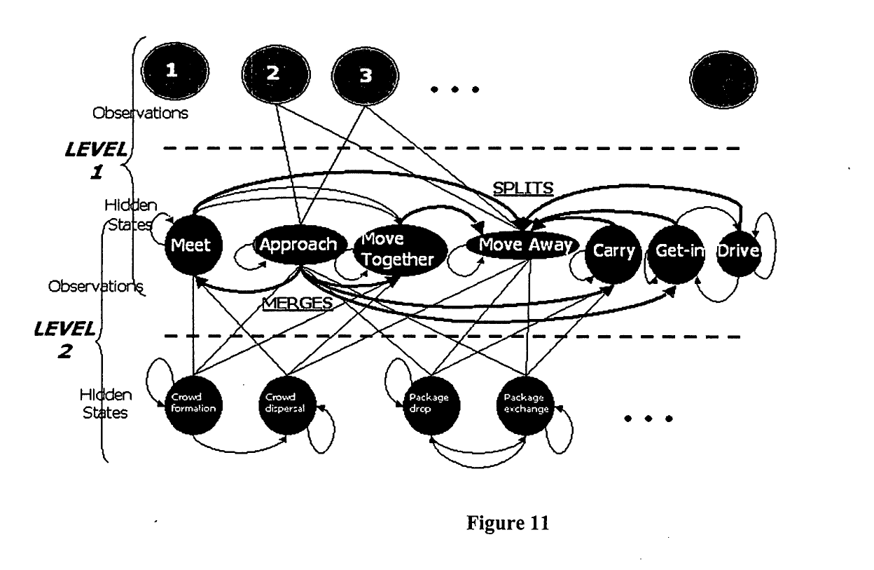

A two-level HMM according to an embodiment of the present invention has been developed to model the hierarchy of simple and complex events. In the first level, the content extracted from the video is used as observations for a seven state HMM model as described supra. The seven states represent the simple events occurring around the splitting and merging of detected objects. The hidden state sequences from the first layer become the observations for the second layer in order to model more complex events such as crowd formation and dispersal and package drop and exchange. The state transitions on the second level are also dictated by split and merge behaviors. FIG. 11 summarizes and depicts a two level model approach according to an embodiment of the present invention. The two levels of the HMM are now described in detail.

The First Level: The HMM model in the first level has seven states, representing most two people or person/object interactions, as follows:

Meet/Wait: one detected object or multiple detected objects merged together into “one” are not moving;

Approach: two detected objects are getting closer to each other;

Move Together: one detected object or multiple detected objects merged together into “one” are moving;

Move Away: two detected objects are getting further away from each other;

Carry: one object is merged with another such that one is holding the other one;

Get-in: one object merged with another is fully encased in the other but not moving; and

Drive: one object is fully encased in another and moving.

Most of the transitions between these states are caused by a split or merge behavior as indicated by dark arrows in FIG. 11, such as two people approaching each other may merge and move together. The observations for the first layer HMM model are the following:

Change of distance between two detected objects;

Distance each object has moved;

Number of objects involved in the split or merge;

Size of each detected object; and

Shape information of each detected object (person, vehicle, package, person with package).

The above observations are grouped into 30 discrete symbols and used to form observation sequences for training the model and for detecting the hidden state sequences. A binary tree representation is used for the discrete observations.

The Second Level: The second level of the HMM models compound and complex events through observation of hidden state patterns from the first level. The range of possible events inferred at this level is large. In order to simplify and define the detection at this level, the model is decomposed into sub-HMMs according to categories of events. The sub-HMMs are standalone HMM models, used as building blocks for a more complex model. During detection, each of these sub-HMMs is executed on an observation sequence in order to produce a possible state sequence. Using log likelihood, the event sequence with the highest likelihood is chosen as the detection result.

Sub-HMM models are defined for people, person and package split/merge interactions. The people sub-HMM model includes two states, Crowd Formation and Crowd Dispersal. The person and package model also includes two states, Package Drop and Package Exchange. The estimated states from the first level as listed above, naturally described by seven discrete symbols, are used to form the observation sequences for training the sub-HMM models and for detecting the hidden state sequences at the second level. For example, a hidden state sequence of“approach-meet-approach-meet-approach-meet” indicates a crowd formation event.

Metadata Insertion

After each step of the analysis process, the results are inserted both into a video analysis database and also back into the video stream itself as metadata. The data about scenes, camera parameters, object features, positions and behaviors etc. is embedded in the video stream. The volume of metadata, compared to the pixel-level digital video “essence” is minimal and does not occupy valuable on-line storage when not needed immediately.

SMPTE provides the Key-Length-Value (KLV) encoding protocol for insertion of the metadata into the video stream. The protocol provides a common interchange point for the generated video metadata for all KLV compliant applications regardless of the method of implementation or transport. The Key is the Universal Label which provides identification of the metadata value. Labels are defined in a Metadata Dictionary specified by the SMPTE industry standard. The Length specifies how long the data value field is and the Value is the data inserted. Using the KLV protocol, the camera parameters, object features, behaviors and a Unique Material Identifier (UMID) are encoded as metadata. This metadata is inserted into the MPEG-2 stream in a frame-synchronized manner so the metadata for a frame can be displayed with the associated frame. A UMID is a unique material identifier defined by SMPTE to identify pictures, audio, and data material. A UMID is created locally, but is a globally unique ID, and does not depend wholly upon a registration process. The UMID can be generated at the point of data creation without reference to a central database.

The video metadata items are: the camera projection point, the camera orientation, the camera focal length, object IDs, object's pixel position, object's area, behavior description code, and two UMIDs, one for the video stream and one for the metadata itself. The metadata items are encoded together into a KLV global set and inserted into a MPEG-2 stream as a separate private data stream synchronized to the video stream. A layered metadata structure is used; the first layer is the camera parameters, the second and the third layers are the object features and the behavior information, and the last layer is the UMIDs. Any subset of layers can be inserted as metadata. The insertion algorithm is described below.

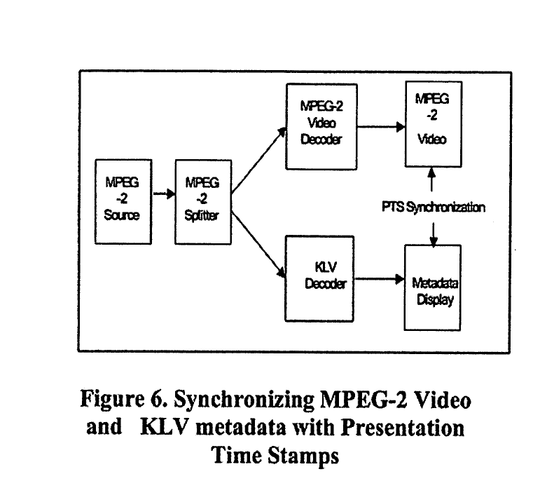

MPEG-2 video streams and KLV encoded metadata are packetized into elementary stream packets (PES). The group of pictures time codes and temporal reference fields from the MPEG-2 video elementary stream are used to create timestamps to place into the PES header's presentation time stamps (PTSs) for synchronization. Those video and KLV metadata PES packets that are associated with each other should contain the same PTS. The PTSs are used to display the KLV and video synchronously (FIG. 6).

When a KLV inserted MPEG-2 program stream is played, the video PES packets and KLV PES packets are divided and delivered to the appropriate decoders. The PTSs are retrieved from those PES packets and are kept with the decoded data. Using the PTSs, the video renderer and the metadata renderer synchronize with each other so that decoded data with the same PTS timestamp are displayed together.

Experimental Results

The experiments with the prototype implementation of the video analysis process with several indoor and outdoor scenarios have produced very good results. Scene detection module testing has been performed on test sets consisting of both indoor and outdoor scene video clips for more than 100 scene changes, including camera operations (pan, zoom and tilts), scene cuts and editing effects such as fades, wipes and dissolves. For all types of scene changes, the scene-change detection process successfully detected and identified the type of scene change. Camera calibration tests for cases with unknown camera orientation, where no closed form solution exists, produced very high accuracy estimates (within a few percent of the true parameter values).

The range of computational performance of the object detection, tracking and video event detection for several different scenarios on standard commercial hardware and software platforms was evaluated. Some initial performance measurements have been developed for our behavioral analysis modules. For example, in one particular embodiment, the CPU requirement per video feed on a 1.7 MHz. Intel dual processor PC with a Windows 2000 operating system ranges from 15% to 25% of CPU capacity in representative surveillance configuration applications. This configuration contained a commercial surveillance digital CCTV system with frame resolution of 352×240 and collected digital video at frame rates ranging from 3.75 frames per second to 15 frames per second, depending on the scene configuration and activity. Consequently, a dedicated system could process the data from up to four cameras for this class of applications.

In general, the computational performance is inversely related to the scene activity as well as to the relative sizes of the objects to be tracked as compared to the image size.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method for video analysis and content extraction, comprising:
scene analysis processing of at least one video input stream;
object detection and tracking for each scene, and;
split and merge behavior analysis for event understanding.

2. The method as claimed in claim 1, further comprising:
storing behavior analysis results.

3. The method as claimed in claim 2, wherein the behavior analysis results are stored in a database.

4. The method as claimed in claim 2, wherein the behavior analysis results are stored in at least one video output stream.

5. The method as claimed in claim 1, wherein the scene analysis processing further includes:
scene change detection.

6. The method as claimed in claim 1, wherein the scene analysis processing further includes:
camera calibration.

7. The method as claimed in claim 1, wherein the scene analysis processing further includes:
scene geometry estimation.

8. The method as claimed in claim 1, wherein the object detection and tracking step further comprises:
identifying a split behavior.

9. The method as claimed in claim 8, wherein the split behavior includes an object splitting into two or more objects.

10. The method as claimed in claim 1, wherein the object detection and tracking step further comprises:
identifying a merge behavior.

11. The method as claimed in claim 10, wherein the merge behavior includes two or more objects merging into a single object.

12. The method as claimed in claim 1, wherein the object detection and tracking step further comprises identifying zero or more split behaviors and zero or more merge behaviors.

13. The method as claimed in claim 12, wherein the split behaviors and merge behaviors are combined to model complex behaviors.

14. The method as claimed in claim 13, wherein the complex behaviors include package drop off, package exchange, crowd formation, crowd dispersal, people entering vehicles, and people exiting vehicles.

15. The method as claimed in claim 1, wherein the behavior analysis step further comprises generating a directed graph including zero or more split behavior states and zero or more merge behavior states.

16. The method as claimed in claim 15, wherein the behavior analysis step further comprises generating a hidden Markov model including the directed graph.

17. The method as claimed in claim 4, wherein the results are stored as metadata.

18. The method as claimed in claim 8, wherein the split behavior identification applies the formula:
Âᵢ^{k+1}∩(Aᵢ^{k+1}∪Aⱼ^{k+1})≠Ø and
m(Âᵢ^{k+1})=r.m(Aᵢ^{k+1}∪Aⱼ^{k+1}).

19. The method as claimed in claim 10, wherein the merge behavior identification applies the formula:
Aₗ^{k+1}∩(Âᵢ^{k+1}∪Âⱼ^{k+1})≠Ø and
m(Aₗ^{k+1})=r.m(Âᵢ^{k+1}∪Âⱼ^{k+1}).

20. The method as claimed in claim 13, wherein the complex behaviors are categorized as one of simple, compound, and chain behaviors.

21. An apparatus for video content analysis comprising:
a processor for receiving and transmitting data; and
a memory coupled to the processor, the memory having stored therein instructions causing the processor to perform scene analysis processing of at least one video input stream, detect and track objects for each scene, and analyze split and merge behaviors for event understanding.

22. The apparatus as claimed in claim 21, wherein the memory further comprises instructions causing the processor to store analysis results in at least one video output stream.

23. The apparatus as claimed in claim 22, wherein the memory further comprises instructions causing the processor to store the results as metadata.

24. The apparatus as claimed in claim 21, wherein the memory further comprises instructions causing the processor to perform at least one of scene change detection, camera calibration, and scene geometry estimation.

25. The apparatus as claimed in claim 21, wherein the instructions causing the processor to detect and track objects for each scene further comprises identifying zero or more split behaviors and zero or more merge behaviors.

26. The apparatus as claimed in claim 25, wherein the instructions causing the processor to identify zero or more split behaviors and zero or more merge behaviors further comprises combining the split and merge behaviors to model complex behaviors.

27. The apparatus as claimed in claim 21, wherein the instructions causing the processor to analyze split and merge behaviors further comprises generating a directed graph including zero or more split behavior states and zero or more merge behavior states.

28. The apparatus as claimed in claim 27, wherein the instructions causing the processor to analyze split and merge behaviors further comprises generating a hidden Markov model including the directed graph.

29. The apparatus as claimed in claim 25, wherein the instructions causing the processor to identify zero or more split behaviors includes the formula:
Âᵢ^{k+1}∩(Aᵢ^{k+1}∪Aⱼ^{k+1})≠Ø and
m(Âᵢ^{k+1})=r.m(Aᵢ^{k+1}∪Aⱼ^{k+1}).

30. The apparatus as claimed in claim 25, wherein the instructions causing the processor to identify zero or more merge behaviors includes the formula:
Aₗ^{k+1}∩(Âᵢ^{k+1}∪Âⱼ^{k+1})≠Ø and
m(Aₗ^{k+1})=r.m(Âᵢ^{k+1}∪Âⱼ^{k+1}).
